(19) United States
(12) Patent Application Publication
(10) Pub. No.: US 2019/0132921 A1
(43) Pub. Date: May 2, 2019

(54) LED DIMMING USING SWITCH MODE POWER SUPPLY CONTROL LOOP PARAMETER MODIFICATION

(71) Applicant: Fulham Company Limited, George Town (KY)

(72) Inventor: Mark Rumer, Portland, OR (US)

(21) Appl. No.: 15/799,841

(22) Filed: Oct. 31, 2017

(51) Int. Cl. H05B 33/08

(52) U.S. Cl. CPC H05B 33/0845; H05B 33/089; H05B 33/0815

(57) ABSTRACT

A dimming light emitting diode (LED) system comprises an LED driver. A switch-mode power supply controller is coupled to the LED driver to drive an LED light source. The LED driver is configured to receive pulse width modulation (PWM) dimming waveform information. The LED driver is configured to modify one or more control loop parameters for the switch-mode power supply controller to dim the LED source based on the PWM dimming waveform information. The PWM waveform information includes a PWM waveform slope, a PWM waveform shape, or a combination thereof.

### FIELD

Embodiments relate to the field of light emitting diode (LED) systems. More specifically, the embodiments relate to a dimming LED system.

### BACKGROUND

Typically, a dimming LED circuit, such as a LED driver, is used to control the brightness of LEDs. LEDs are increasingly being used instead of incandescent bulbs. LEDs provide several advantages over conventional light sources, which include lower energy consumption, longer lifetime, improved physical robustness, smaller size, and faster switching.

Dimming LED circuits have several methods to control the brightness of LEDs. One method is pulse width modulation (PWM) dimming. PWM dimming switches a switch to control the average of LED current supplied to the LEDs. Another method is direct-current (DC) dimming. DC dimming controls the LED current that is supplied to the LEDs. An alternative method is combining PWM and DC dimming.

Dimming LED circuits can, however, present several disadvantages. One disadvantage of a dimming LED circuit is unpredictable operation across multiple LEDs of the same installation. Other disadvantages encountered with a dimming LED circuit are the limited number of parameters that are available and the inconsistency of the parameters. Typically, some of the parameters include photometric response, LED temperature, LED color output over time, gamma variation, and LED intensity variation.

Another disadvantage of conventional dimming LED circuits is that LEDs usually have shortened lifetimes. Typically, the LED input power of the dimming LED circuit is increased as the LED drive respectively increases the brightness of the LEDs to a desired luminance level. This increased LED drive reduces the overall LED source lifetime and thus leads to additional replacements and increased costs.

### SUMMARY

Methods and apparatuses to provide an LED dimming using switch mode power supply control loop parameter modification are described. For one embodiment, a dimming light emitting diode (LED) system comprises an LED driver and a switch-mode power supply controller coupled to the LED driver to drive an LED light source. The LED driver is configured to receive pulse width modulation (PWM) dimming waveform information. The LED driver is configured to modify one or more control loop parameters for the switch-mode power supply controller to dim the LED source based on the PWM dimming waveform information. The PWM waveform information includes a PWM waveform slope, a PWM waveform shape, or a combination thereof.

For one embodiment, a dimming light emitting diode (LED) driver circuit comprises a memory and a management unit comprising a processor coupled to the memory. The processor is configured to receive pulse width modulation (PWM) dimming waveform information. The processor is configured to modify one or more control loop parameters to dim a LED source based on the PWM dimming waveform information. The PWM waveform information includes a PWM waveform slope, a PWM waveform shape, or a combination thereof.

For one embodiment, a method to dim an LED source comprises receiving pulse width modulation (PWM) dimming waveform information and modifying one or more control loop parameters to dim the LED source based on the PWM dimming waveform information. The PWM waveform information includes a PWM waveform slope, a PWM waveform shape, or a combination thereof.

For one embodiment, a non-transitory machine readable medium comprises instructions that cause a data processing system to perform a method to dim an LED source that comprises receiving pulse width modulation (PWM) dimming waveform information and modifying one or more control loop parameters to dim the LED source based on the PWM dimming waveform information. The PWM waveform information includes a PWM waveform slope, a PWM waveform shape, or a combination thereof.

Other advantages and features will become apparent from the accompanying drawings and the following detailed description.

### BRIEF DESCRIPTION OF THE DRAWINGS

Embodiments described herein illustrated by way of example and not limitation in the figures of the accompanying drawings, in which like references indicate similar features. Furthermore, some conventional details have been omitted so as not to obscure from the inventive concepts described herein.

FIG. 1 is a block diagram of a dimming LED system according to one embodiment.

FIG. 2 is a block diagram of a dimming LED system, according to one embodiment.

FIG. 3 is a block diagram of a dimming LED system according to one embodiment.

FIG. 4 is a block diagram of a dimming LED system according to one embodiment.

FIG. 5 is a block diagram of a dimming LED system according to one embodiment.

FIG. 6 is a block diagram of a dimming LED system according to one embodiment.

FIG. 7 is a block diagram of a portion of a dimming LED system according to one embodiment.

FIG. 8 is a flow chart illustrating a method for dimming an LED source according to one embodiment.

FIG. 9 is a block diagram illustrating a data processing system for dimming an LED source according to one embodiment.

### DETAILED DESCRIPTION

Methods and apparatuses to provide an LED dimming by modification of switch mode power supply control loop parameters are described. For one embodiment, a dimming light emitting diode (LED) system comprises an LED driver and a switch-mode power supply controller coupled to the LED driver to drive an LED light source. The LED driver is configured to receive pulse width modulation (PWM) dimming waveform information. The LED driver is configured to modify one or more control loop parameters for the switch-mode power supply controller to dim the LED source based on the PWM dimming waveform information. The PWM waveform information includes a PWM waveform slope, a PWM waveform shape, or a combination thereof. For one embodiment, the LED source is an LED source array that comprises a plurality of light emitting diodes (LEDs).

For one embodiment, the LED driver of the dimming LED system includes a microcontroller and/or a digital signal processor (DSP). The microcontroller and DSP are configured to control a wave shape and/or a slope of the PWM dimming waveform to dim the LED source. A unified switching power supply and PWM dimming circuit use a digital signal processor as a controller. The PWM dimming is emulated in firmware by modulating one or more LED source drive parameters, e.g., a power supply drive voltage, a power supply drive current, or power (a combination of the drive voltage and current). The PWM slope and wave shape are synthesized in firmware. The LED driver includes a processor that is configured to control of a wave shape and/or a slope of the PWM dimming waveform. The dimming apparatuses and systems described herein are implemented in hardware, firmware, or a combination of hardware and firmware.

Traditional PWM dimming uses a high-speed switch which turns the LED array on/off that causes fast edge rates, radiated Electro-Magnetic Interference (EMI), audible noise, distracting stroboscopic flicker, and current surges which thermally stress LED semiconductor junctions. The dimming LED system described herein beneficially minimizes the PWM dimming-induced LED flicker by controlling a wave shape and/or a slope of the PWM dimming waveform. The stroboscopic flicker is beneficially minimized by blurring harsh PWM transitions using the slope and/or wave shape control. The current induced thermal stress in the LED semiconductor junction and the current induced acoustic shock (e.g., whine and buzzing) are minimized by eliminating hard on/off transitions.

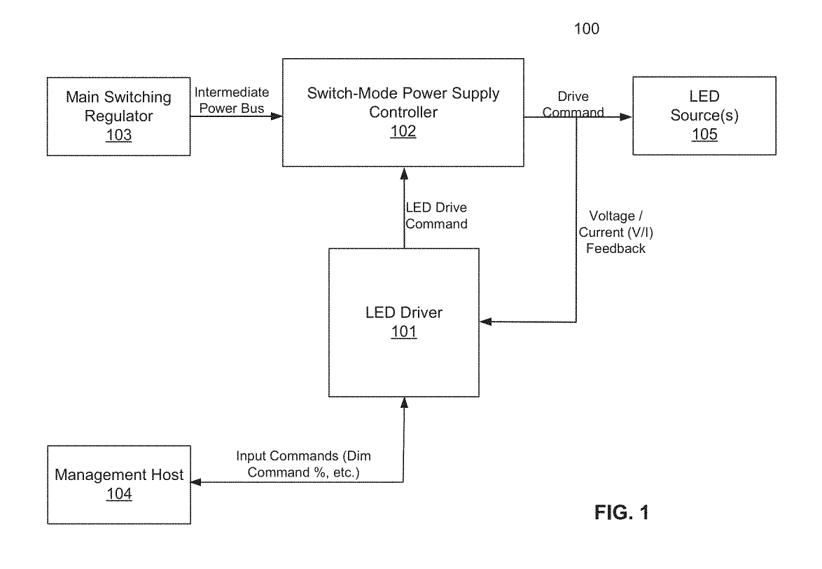

FIG. 1 shows a block diagram of a dimming LED system 100. The dimming LED system 100 includes an LED driver 101, a switch-power supply controller 102, a main switching regulator 103, a management host 104, and a light source 105. For one embodiment, light source 105 is an LED source array comprising a plurality of LEDs. The LED driver 101 receives one or more input commands to dim the light source 105 from the management host 104. The management host 104 comprises a processor that sends the one or more input commands to the LED driver 101 to dim the light source 105 to a predetermined percentage. Dimming refers to the reduction in a measured lumen output relative to a predetermined lumen output and is defined by a dimming ratio (e.g., dimming percentage). The input command includes a desired dimming ratio. As shown in FIG. 1, LED driver 101 is connected to management host 104 by a two-way communication link. For one embodiment, LED driver 101 includes a processor. For one embodiment, LED driver 101 includes a microcontroller, a DSP, or both a microcontroller and a DSP. The LED driver 101 outputs an LED drive command to the switch-mode power supply controller to dim the LED light source array in response to receiving the one or more input commands from the management host 104. The LED driver 101 determines a target dimming ratio based on the input command to dim to a desired percentage and one or more LED performance parameters and outputs the LED drive command based on the target dimming ratio. For one embodiment, the one or more LED performance parameters include a photometric response parameter, a gamma parameter, an aging parameter, a temperature parameter, a colormetric feedback from the light source 105, a photometric feedback from the light source 105, or any combination thereof. Dimming LED Driver 101 performs gamma compensation and determines a target dimming ratio based upon (1) an input command to dim to a certain percentage, (2) target intensities of the light source 105 associated with the one or more LED parameters identified in tables, and (3) optional photometric feedback from the light source 105, as described in further detail below.

An input command to dim the light source 105 to a desired intensity is provided by a control network. Management host 104 represents a control network. For one embodiment, the LED drive level is selected by interpolating between the closest values in gamma, aging, and temperature compensation tables. For one embodiment, the gamma, aging, and temperature compensation tables are programmed with photometric response, aging, and temperature characteristic curves specific to the driven LED source array, as described in further detail below.

A photometric sensor collocated with the light source 105 provides a feedback to the LED driver 101. LED driver 101 computes an error value and adds the error value to the drive level value that compensates for intensity variation and source aging from one light source to another light source. If the error value exceeds a predetermined threshold, the control network is notified so that maintenance may be performed.

As shown in FIG. 1, the switch-mode power supply controller 102 receives an output from main switching regulator 103. The output of the main switching regulator signal is an intermediate power bus output. The switch-mode power supply controller 102 outputs a drive command to drive the light source 105 based on the LED command send from the LED driver 101 and the intermediate power bus signal. For one embodiment, the switch-mode power supply controller 102 comprises a two-channel buck converter. The buck converter is a DC-to-DC power converter that steps down voltage while stepping up current from its input (e.g., power supply) to its output (e.g., load).

As shown in FIG. 1, feedback data from the light source 105 are sent back to the LED driver 101. For one embodiment, the feedback data include a driving voltage, a driving current, a driving duty cycle, or any combination thereof.

The LED driver 101 outputs the LED drive command based on one or more tables (not shown in FIG. 1) that map the one or more LED parameters to at least one of a drive voltage parameter, a drive current parameter and a duty cycle parameter, as described in further detail below. The LED driver 101 interpolates between at least two values of the one or more LED parameters. The LED driver 101 computes an error value for the one or more LED parameters.

The LED driver 101 receives an input LED setting information and determines compensation values according to the received input LED setting information and the one or more LED parameters. The LED driver 101 generates an output LED setting information based on the compensation values. The LED driver 101 determines a target dimming ratio based on target intensities of the LED source array associated with the one or more LED parameters, as described in further detail below.

For one embodiment, the LED driver 101 is configured to receive pulse width modulation (PWM) dimming waveform information. The PWM waveform information includes a PWM waveform slope, a PWM waveform shape, or a combination thereof. The LED driver is configured to modify one or more control loop parameters for the switch-mode power supply controller 1022 to dim the LED source 105 based on the PWM dimming waveform information, as described in further detail below. The LED driver 101 is configured to determine one or more drive parameters to drive the LED source 105 based on the modified one or more control loop parameters. The one or more drive parameters include a drive voltage parameter, a drive current parameter, a drive power parameter, or any combination thereof. The LED driver 101 is configured to output a PWM control signal based on the determined one or more drive parameters. The LED driver 101 is configured to determine one or more compensation values for one or more LED parameters. The LED driver is configured to modify the one or more control loop parameters based on the one or more compensation values, as described in further detail below. The LED driver 101 is configured to generate one or more control loop parameter modifiers using at least the PWM waveform information, as described in further detail below.

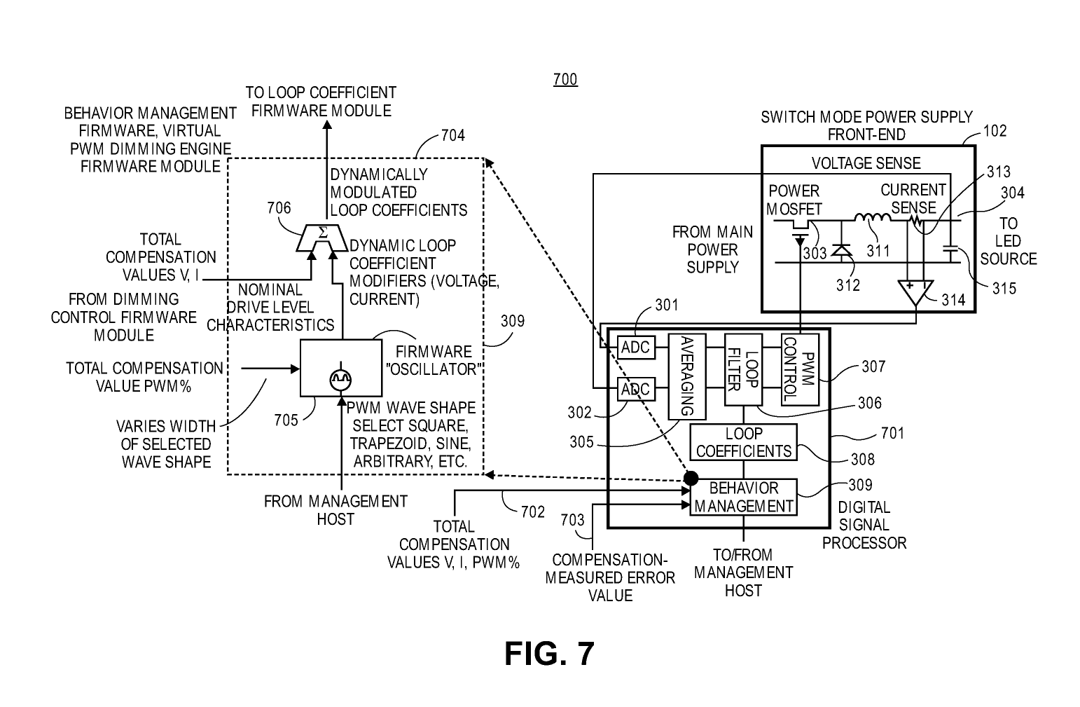

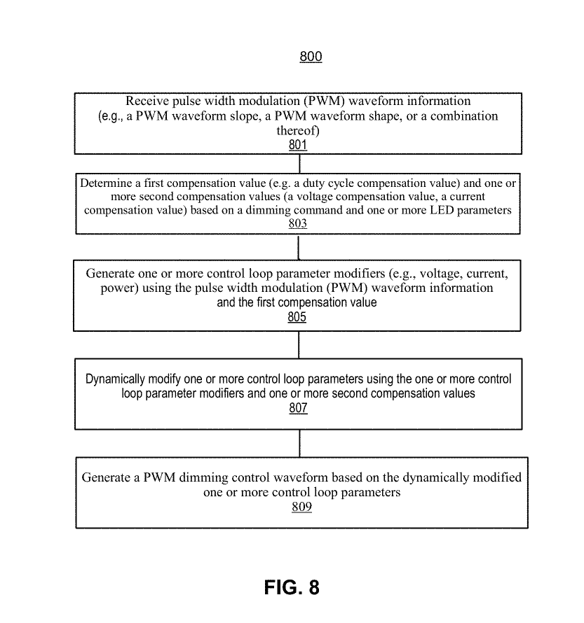

For one embodiment, the PWM dimming LED driver 101 is configured to determine the drive voltage and current characteristics through modulation of switch mode power supply control loop parameters (coefficients) implemented in a DSP. The PWM waveform is synthesized by modifying a drive voltage, a drive current, and/or a drive power on a periodic basis according to a wave shape (e.g.: sine, trapezoidal, arbitrary function, and other wave shapes) that is selected to minimize the negative environmental impacts of the PWM LED dimming, as described in further details below with respect to FIGS. 7 and 8. For one embodiment, the wave shape includes a square, a rectangular, a sine, a trapezoidal, an arbitrary function shape, or any combination thereof. For one embodiment, the wave shape is any shape other than square or rectangular.

For one embodiment, the PWM dimming LED system 100 uses a firmware-based DSP power regulation and control. The control algorithm only regulates the drive characteristics (parameters) during the ‘on’ period, otherwise the drive is idle. The drive parameters are configurable and programmable. The dimming LED system 100 is configured to modulate the output voltage and current of the regulator simulating a PWM waveform using a firmware-based DSP algorithm, as described in further details below with respect to FIGS. 7 and 8. This eliminates the extra switching transistor and inductor stage that simplifies the dimming LED system. The dimming LED system described herein provides a greater degree of control over dimming characteristics by setting unique duty-cycle and current ratios that ensures consistent light and color output of the LED source comparing to conventional LED systems.

For one embodiment, the LED driver 101 coupled to the switch-mode power supply controller 102 are used to increase the LED source's useful life span, minimize radiated audible noises and electromagnetic interference (EMI), and provide full parametric control over the LED source drive, as described in further detail below.

For one embodiment, the dimming LED system 100 includes a DSP based switch mode power supply controller with firmware to facilitate control over one or more drive parameters, e.g., a drive current, a drive voltage, and/or a drive power, with these parameters taking the form of control loop coefficients. The PWM dimming function is emulated by modulating the control loop coefficients according to a synthesized waveform of a predetermined shape with the effect of smoothing the PWM drive, as described in further details below with respect to FIGS. 7 and 8. This minimizes the LED semiconductor junction thermal shock, electromagnetic interference, audible noise, and stroboscopic flicker.

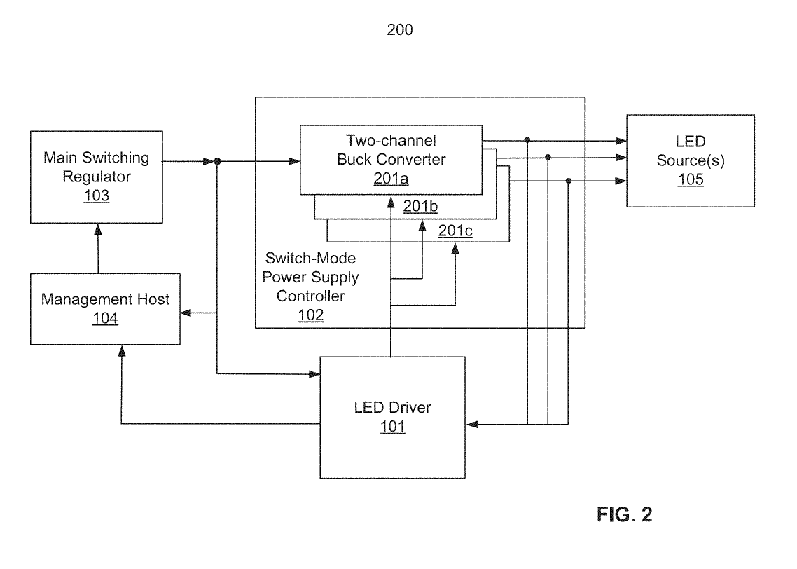

FIG. 2 is a block diagram of a dimming LED system 200. Dimming LED system 200 includes LED driver 101, switch-power supply controller 102, main switching regulator 103, management host 104 and light source 105 that are described above with respect to FIG. 1. As shown in FIG. 2, switch-power supply controller 102 includes daughter cards 201a, 201b, and 201c. The daughter card refers to a printed circuit board that plugs into another printed circuit board, which plugs into a main circuit board (motherboard).

For one embodiment, each of the daughter cards 201a, 201b, and 201c includes a two-channel DC/DC buck converter. The two-channel DC/DC buck converters of the daughter cards 201a, 201b and 201c have the same designs.

As shown in FIG. 2, each of the switch-mode power supply controller 102, LED driver 101, and management host 104 receives an output of the main switching regulator 103. The LED driver 101 outputs an LED drive command to each of the two-channel buck converters 201a, two-channel buck converter 201b, and two-channel buck converter 201c to dim the LED light source 105. The LED driver 101 determines a target dimming ratio based on the input command from the management host 104 to dim to a desired percentage and one or more LED performance parameters. The LED driver 101 outputs the LED drive command based on the target dimming ratio. For one embodiment, the one or more LED parameters include a photometric response parameter, a gamma parameter, an aging parameter, a temperature parameter, a colormetric feedback from the LED source 105, a photometric feedback from the LED source 105, or any combination thereof, as described above.

As shown in FIG. 2, the output of the main switching regulator 103 is fed into the switch-mode power supply controller 102, LED driver 101, and management host 104. As shown in FIG. 2, each of the two-channel buck converters of the daughter cards 201a, 201b, and 201c provides an output drive signal to the LED source 105. The LED driver 101 provides an input drive signal to each of the two-channel DC/DC converters of the daughter cards 201a, 201b, and 201c, as shown in FIG. 2. The output drive signal from each of the two-channel DC/DC converters of the daughter cards 201a, 201b, and 201c is fed back to the LED driver 101. As shown in FIG. 2, the LED driver 101 controls each of the two-buck converters of the daughter cards 201a, 201b, and 201c based on the output current and output voltage of the output drive signal.

The DSP of the LED driver 101 controls the 6 channel DC/DC output of the switch-mode power supply controller to a pre-determined voltage level, a predetermined current level, or the predetermined voltage level and the predetermined current level. The DSP of the LED driver 101 senses an output current and an output voltage of each channel of the DC/DC buck converters. The DSP of LED driver 101 calculates a target pulse-width modulation (PWM) signal combining the programming signal for an output voltage and/or an output current to drive each channel of the buck converters of the switch-mode power supply controller 102. For one embodiment, the DSP of the LED driver 101 reports the sensing information and operating status to management host 104.

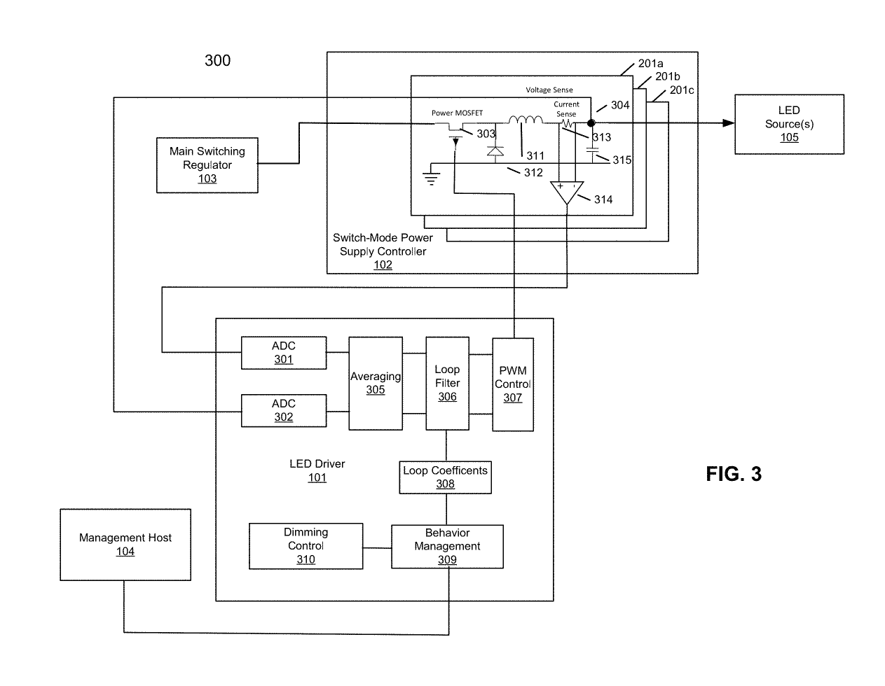

FIG. 3 is a block diagram of a dimming LED system 300 according to one embodiment. Dimming LED system 300 includes LED driver 101, switch-power supply controller 102, main switching regulator 103, management host 104, and light source 105, as discussed above with respect to FIGS. 1 and 2. As shown in FIG. 3, switch-power supply controller 102 includes daughter cards 201a, 201b, and 201c, as described above with respect to FIG. 2. System 300 is implemented as hardware, firmware, or a combination of hardware and firmware.

As shown in FIG. 3, each of the daughter cards 201a, 201b, and 201c includes a two-channel DC/DC buck converter, as described above with respect to FIG. 2. The two-channel DC/DC buck converters of the daughter cards 201a, 201b, and 201c have the same designs. As shown in FIG. 3, the two-channel DC/DC buck converter 201a includes a power metal oxide semiconductor field effect transistor (MOSFET) 303 coupled to an inductor 311 and a diode 312. A current sense resistor 313 is coupled to the inductor 311 and an amplifier 314. A capacitor 315 is between node 304 and ground.

LED driver 101 has a DSP sub-system for each of the two-channel DC/DC buck converters of the daughter cards 201a, 201b, and 201c. As shown in FIG. 3, the DSP sub-system of the LED driver 101 includes an analog-to-digital converter (ADC) 301 and an ADC 302, an averaging function block 305, a control loop filter block 306, a pulse width modulation (PWM) control block 307, a loop coefficients block 308, a behavior management block 309, and a dimming control block 310.

The ADC block 301 is an analog to digital converter that resides in the digital signal processor integrated circuit of the LED driver 101 to convert a drive current representation of the LED light source 105 to a digital value. The ADC block 302 is an analog-to-digital converter that resides in the digital signal processor integrated circuit of the LED driver 101 to convert an anode voltage representation of the LED light source 105 to a digital value. As shown in FIG. 3, ADC block 301 is connected to the output of the amplifier 314 of the switch-mode power supply controller 102. ADC block 302 is connected to the node 304 of the switch-mode power supply controller 102.

The resulting values of the ADC block 301 and the ADC block 302 are then digitally filtered via an averaging algorithm of the averaging function block 305 to reduce noise and digital conversion alias artifacts. These averaged and filtered values are then presented to control loop filter block 306 which determines the proper pulse width to be applied to the PWM control block 307 based upon target voltage and current drive characteristics and control loop response behavior coefficients provided by the loop coefficients block 308.

As shown in FIG. 3, the PWM control block 307 provides a switch control signal for the power MOSFET of the LED channel of the corresponding buck converter (e.g., residing on daughter card 201a). The proportional period of time the switch is ON is determined by results from the loop filter block 306. As shown in FIG. 3, the behavior management block 309 is connected to the dimming control block 310, loop coefficients block 308 and management host 104. Behavior management block 309 controls loop coefficients block 308 based on an output of the dimming control block 310, and an output of the management host 104. When at least one of an average sensed drive voltage and an average sensed drive current is below a target value, the loop filter block 306 demands increasing a portion of ON-time from PWM Control 307. When at least one of an average sensed drive voltage and an average sensed drive current exceeds a target value, the loop filter block 306 demands decreasing a portion of ON-time from PWM Control 307. Under normal operational conditions, equilibrium is attained and only minor adjustments to the portion of ON-time from PWM Control 307 are required.

As shown in FIG. 3, when the power MOSFET 303 turns ON, the DC power of the main switching regulator output applies to inductor 311, current sense resistor 313, and the LED source 105 (load). Inductor 311 is energized and behaves as a voltage drop on the LED source 105. The diode 312 is reverse biased. Then power MOSFET 303 turns OFF, and inductor 311 releases the energy that was previously stored to the LED source 105 and diode 312. By controlling the ON/OFF state of the power MOSFET 303 the expected output current and voltage values can be achieved. The controlling the ON/OFF state of the power MOSFET 303 is realized by the DSP of the LED driver 101. The DSP of the LED driver 101 senses the output current through current sense resistor 313 and senses the output voltage through node 304, and controls the transistor 303. An amplified sensed current signal is sent through an amplifier 314 to ADC 301 of the LED driver 101. A sensed voltage signal is sent to ADC 302 of the LED driver 101, as shown in FIG. 3.

The DSP sub-system circuits of the LED driver 101 are configured to control six output channels of the DC/DC buck converters of the switch-mode power supply controller 102 to be at a pre-determined drive voltage level and a predetermined drive current level. Each of the DSP sub-system circuits of the LED driver 101 (1) senses the output current and the output voltage of the corresponding DC/DC buck converter of the switch-mode power supply controller, (2) calculates the demand PWM signal that combines the programming signal for the output voltage and current, and (3) outputs the PWM signal to drive the corresponding channel of the DC/DC buck converters.

The DSP sub-system of the LED driver 101 reports the sensing information and operating status to the management host 104. The DSP sub-system of the LED driver 101 senses the front end bus voltage (input for the buck circuit). The DSP sub-system of the LED driver 101 adjusts the front end bus voltage according to the load condition.

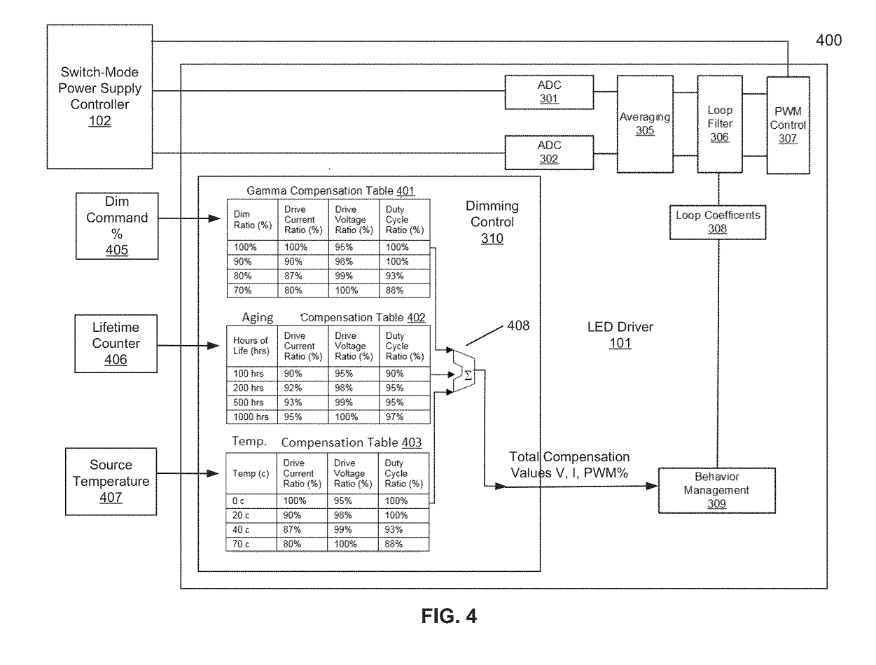

FIG. 4 is a block diagram of a dimming LED system 400 according to one embodiment. The dimming LED system 400 includes LED driver 101 coupled to switch-mode power supply controller 102, as described above. As shown in FIG. 4, the LED driver 101 includes ADC 301, ADC 302, averaging function block 305, control loop filter block 306, PWM control block 307, loop coefficients block 308, behavior management block 309, and dimming control block 310, as described above with respect to FIG. 3. ADC 301 and ADC 302 and PWM control block 307 are connected to switch-mode power supply controller 102, as described above.

As shown in FIG. 4, dimming control block 310 includes a gamma compensation table 401, an aging compensation table 402, and a temperature compensation table 403. Gamma compensation table 401 maps target values of a drive current ratio (%), a drive voltage ratio (%) and a duty cycle ratio (%) needed to drive the LED light source to obtain target values of a dimming ratio (%) of the LED light source. Target values of a drive current ratio (%), a drive voltage ratio (%), and a duty cycle ratio (%) are selected using the gamma compensation table 401 based on a dimming command 405 from a management or control host (e.g., management host 104).

For a non-limiting example, the dimming command includes a dimming ratio of 80% is received. In response to this dimming command, a drive current ratio of 87%, a drive voltage ratio of 99%, and a duty cycle ratio of 93% that correspond to the dimming ratio of 80% are selected as an output from the gamma compensation table 401.

Aging compensation table 402 maps target values of a drive current ratio (%), a drive voltage ratio (%), and a duty cycle ratio (%) needed to drive the LED light source that correspond to the target age (e.g., hours of life) of the LED light source. For one embodiment, target values of a drive current ratio (%), a drive voltage ratio (%), and a duty cycle ratio (%) are selected using the aging compensation table 402 based on an input from a lifetime counter 406. For one embodiment, lifetime counter 406 is an internal lifetime counter. For another embodiment, lifetime counter 406 is an external lifetime counter.

For a non-limiting example, the input from the lifetime counter 406 indicating that the age of the LED light source is 200 hours is received. In response to this input, a drive current ratio of 92%, a drive voltage ratio of 98%, and a duty cycle ratio of 95% that correspond to the 200 hours of life are selected as an output from the aging compensation table 402.

Temperature compensation table 403 maps target values of a drive current ratio (%), a drive voltage ratio (%), and a duty cycle ratio (%) needed to drive the LED light source that correspond to the target temperature of the LED light source. Values of a drive current ratio (%), a drive voltage ratio (%), and a duty cycle ratio (%) are selected using the temperature compensation table 403 based on an input from a source temperature block 407. Source temperature block 407 represents an external temperature sensor.

For a non-limiting example, the input from the source temperature block 407 indicating that the temperature of the LED light source is 40 degrees C. is received. In response to this input, a drive current ratio of 87%, a drive voltage ratio of 99%, and a duty cycle ratio of 93% that correspond to the temperature of 40 degrees C. are selected as an output from the temperature compensation table 403.

That is, the target values of the PWM duty-cycle, drive voltage, and drive current to drive the LED light source are selected based on the source aging and temperature characteristics and Gamma correction using compensation tables 401, 402, and 403. This beneficially extends the useful life of the light source and ensures optical consistence over service.

Each of the compensation tables 401, 402, and 403 has an arbitrary number of entries. A linear interpolation between the two nearest table entries is performed to ensure smooth transition across the dimming range. For one embodiment, the drive voltage, the drive current, and driving duty cycle are modified with modifier values that take into account the LED source aging.

As shown in FIG. 4, the output compensation values of the drive current ratio, the drive voltage ratio and the duty cycle ratio from each of the tables 401, 402, and 403 are summed at a summation block 408 that outputs total compensation values for the drive current ratio, the drive voltage ratio and the duty cycle ratio to behavior management block 309. For one embodiment, summation block 408 includes an interpolation function.

For one embodiment, a hybrid method of controlling dimming of an LED light source to compensate for the human photometric response, increase the source's useful life span, compensate for device tolerance variation, and nonlinearities in the LED source response to voltage, current, temperature, and aging is described. The system includes a digital signal processor (DSP) based switch mode power supply controller with firmware to implement parametric source compensation and life extension algorithms. The firmware modifies LED drive voltage and current according to desired dimming level according to tables describing operational characteristics. Optional sensors may be provided to measure operational characteristics to further compensate for accumulated errors, and provide feedback to control and management applications when operational parameters are exceeded.

For one embodiment, a dimming command is received from one or more control interfaces. Firmware in the DSP validates the command, then selects and interpolates values of the two closest entries in a table representing human photometric response and LED luminance characteristics with respect to a drive voltage and current, indexed by dimming ratio. The amount of LED drive current, drive voltage percentage is modified according to this interpolation. Meanwhile, another table represents luminance characteristics of the LED source with respect to temperature, and yet another table represents luminance with respect to operational lifetime. All these results are summed to modify the LED drive voltage and current to normalize the affect of these characteristics. For one embodiment, a sensor co-located with the LED source measures at least one of resulting luminance and color and provides a feedback to the LED driver which then further modifies the drive level. If the deviation of the drive parameter exceeds a predetermined amount, error information is passed to the control and management application.

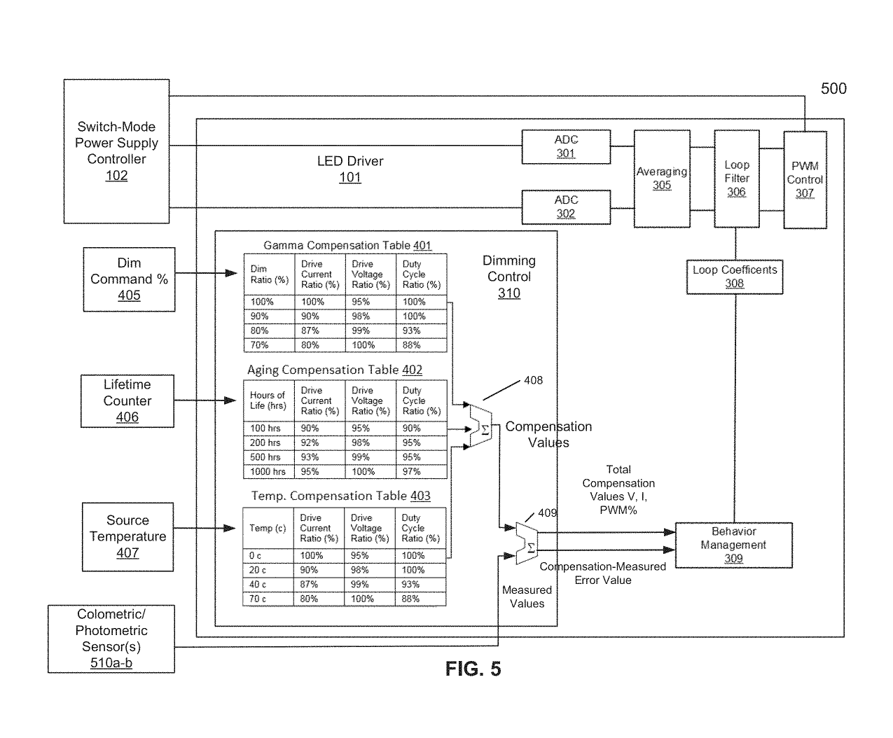

FIG. 5 is a block diagram of a dimming LED system 500 according to one embodiment. The dimming LED system 500 includes LED driver 101 coupled to switch-mode power supply controller 102, as described above. As shown in FIG. 5, the LED driver 101 includes ADC 301, ADC 302, averaging function block 305, control loop filter block 306, PWM control block 307, loop coefficients block 308, behavior management block 309, and dimming control block 310, as described above. ADC 301 and ADC 302 and PWM control block 307 are connected to switch-mode power supply controller 102, as described above. Dimming control block 310 includes a gamma compensation table 401, an aging compensation table 402 and a temperature compensation table 403, as described above. FIG. 5 is different from FIG. 4 in that the LED driver 101 receives a colormetric feedback, a photometric feedback, or the colormetric feedback and photometric feedback from colormetric and photometric sensors 510a-b of the LED source. The colormetric and photometric feedbacks from the LED source sensors is provided to one of the inputs of a summation block 409. The total compensation values for the drive current ratio, the drive voltage ratio, and the duty cycle ratio from the summation block 408 are provided to other inputs of the summation block 409. The summation block 409 outputs total compensation values for the drive current ratio, the drive voltage ratio, and the duty cycle ratio to behavior management block 309. The summation block 409 outputs a compensation-measured error value for the one or more LED parameters from colormetric and photometric sensors 510a-b of the LED source to the behavior management block 309. For one embodiment, summation block 409 includes an interpolation function.

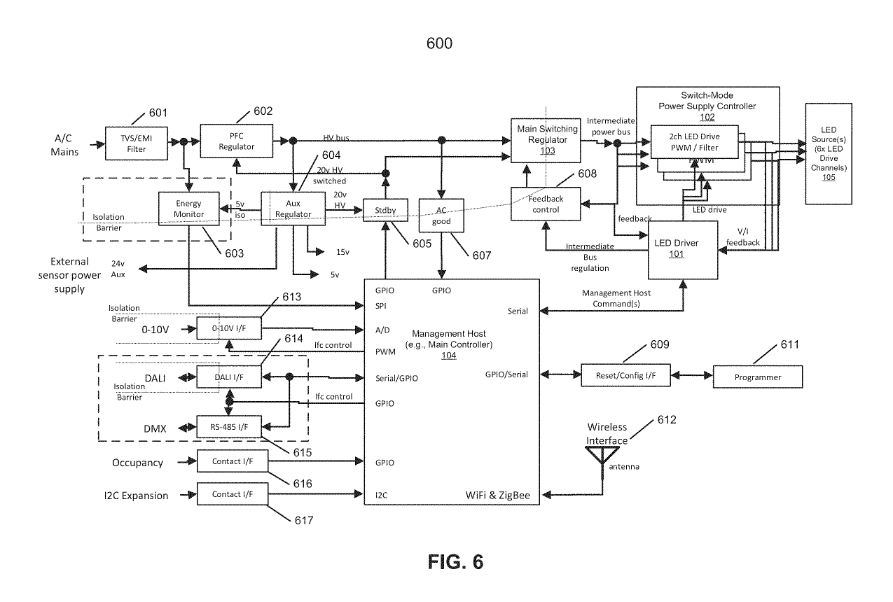

FIG. 6 shows a block diagram of a dimming LED system 600 according to one embodiment. The dimming LED system 600 includes LED driver 101, switch-power supply controller 102, main switching regulator 103, management host 104 and light source 105, as described above. As shown in FIG. 6, dimming LED system 600 includes aTVS/EMI filter 601 connected to a PFC regulator 602 and an energy monitor 603. For one embodiment, energy monitor 603 represents an energy monitor card. An output of the PFC regulator 602 is connected to an auxiliary regulator 604 that provides an input to the energy monitor 603 and to a standby block 605. Standby block 605 provides an input to the PFC regulator 602, and main switching regulator 103. An output of the PFC regulator 602 is connected to main switching regulator 103. The output of the PFC regulator 602 is connected to management host 104 via an AC good block 607. Management host 104 receives inputs from a plurality of interfaces, such as a reset/configuration interface (IF) 609, a wireless interface 612, 0-10V IF 613, digitally addressable lighting interface (DALI) 614, DMX RS-485 IF 615, a contact IF 616, and a contact IF 617, as shown in FIG. 6. For one embodiment, DALI 614 and DMX RS-485 IF 615 represent a wired control network physical layer interface card. For one embodiment, contact IF 616 and contact IF 617 represent optional sensor interfaces. As shown in FIG. 6, a user (e.g., a programmer) 611 communicates with management host 104 via reset/configuration IF 609. Management host 104 is coupled to LED driver 101 via a bi-directional link, as shown in FIG. 6. LED driver 101 provides an input to a feedback control block 608 that is connected to the main switching regulator 103. Main switching regulator 103 provides inputs to the channels of the buck converters of the switch-mode power supply controller 102 and to the feedback control block 608. LED driver 101 is connected to drive the channels of the buck converters of the switch-mode power supply controller 102. LED driver 101 is coupled to the output of the main switching regulator 103.

FIG. 7 is a block diagram of a portion of the dimming LED system 700 according to one embodiment. The dimming LED system 700 represents a portion of one of the LED systems described above. The dimming LED system 700 includes a LED driver 701 coupled to switch-mode power supply controller 102. LED driver 701 represents a portion of the LED driver 101. As shown in FIG. 7, the LED driver 701 includes ADC 301, ADC 302, averaging function block 305, control loop filter block 306, PWM control block 307, loop coefficients block 308, behavior management block 309, as described above. As shown in FIG. 7, the switch-mode power supply controller 102 includes power metal oxide semiconductor field effect transistor (MOSFET) 303 coupled to inductor 311 and diode 312. Current sense resistor 313 is coupled to the inductor 311 and amplifier 314. Capacitor 315 is between node 304 and ground, as described above.

The behavior management block 309 receives total compensation values of the drive voltage (V), drive current (I), and duty cycle (PWM %) 702, and a compensation measured error value from dimming control block 310, as described above. The behavior management block 309 receives the PWM dimming waveform information from management host 104, as shown in FIG. 7. The PWM waveform information includes a PWM waveform slope, a PWM waveform shape, or any combination thereof

An insert 704 shows components of the behavior management block 309. Behavior management block 309 includes a firmware oscillator 705 that receives the PWM dimming waveform information, e.g., a PWM waveform slope, a PWM waveform shape, or any combination thereof from management host 104. For one embodiment, a wave shape (e.g.: sine, trapezoidal, arbitrary function, or other wave shape) of the PWM waveform is selected to minimize the negative environmental impacts of the PWM LED dimming. Firmware oscillator 705 receives the total compensation value of the duty cycle (PWM %), as shown in FIG. 7. The width of the PWM waveform of the selected shape is adjusted according to the received total compensation value PWM %. Firmware oscillator 705 outputs dynamic loop coefficient modifiers to modify drive parameters (e.g., voltage, current, power, duty cycle), as shown in FIG. 7. For one embodiment, firmware oscillator 705 generates dynamic loop coefficient modifiers according to the adjusted width of the PWM waveform having the selected shape. A summation block 706 is connected to the firmware oscillator 705, as shown in FIG. 7. For one embodiment, summation block 706 acts as a multiplier to multiply at least one of a slope and a shape of the PWM waveform by the one or more control loop parameters. Total compensation values of the drive voltage (V) and drive current (I) that represent nominal drive level characteristics are provided to one input of the summation block 706, as shown in FIG. 7. Other input of the summation block 706 receives the dynamic loop coefficient modifiers from firmware oscillator 705, as shown in FIG. 7. The summation block 706 outputs dynamically modulated control loop parameters (coefficients) to the control loop coefficients firmware module (block 308), as shown in FIG. 7.

For one embodiment, a dimming command received by the LED driver 101 from the control interface (e.g., represented by management host 104) is processed into modifier ratios for drive voltage, current, and PWM duty cycle. The dimming command includes pulse width modulation (PWM) dimming waveform information, e.g., values representing the PWM waveform slope, shape, or both the PWM waveform slope and shape. The behavior management firmware block 309 processes these values into switch mode power supply control loop coefficients. In particular, when presented with a desired PWM duty cycle, the firmware oscillator 705 with a configurable wave shape is multiplied by the control loop coefficients, modulating drive characteristics. The results have the effect of ramping LED drive voltage and/or current up and down with the net duty cycle requested, but with an envelope determined by the wave shape. Because the envelope lacks hard transitions, radiated EMI and audible noise is minimized, and the smoothed response reduces the effect of observable stroboscopic flicker by blurring motion. Removing instantaneous ‘on’ transitions reduces thermal shock in LED junctions.

FIG. 8 is a flow chart illustrating a method for dimming an LED source according to one embodiment. At operation 801 a pulse width modulation (PWM) waveform information is received. The PWM information includes the information regarding a PWM waveform slope, a PWM waveform shape, or information regarding both the PWM waveform slope and the PWM waveform shape, as described above. At operation 803 a first compensation value and one or more second compensation values are determined based on a dimming command and one or more LED parameters. The first compensation value is a total compensation value for the duty cycle ratio. The one or more second compensation values are total compensation value for the drive current ratio, the drive voltage ratio, or the drive current ratio and the drive voltage ratio, as described above. The one or more LED parameters include a photometric response parameter, a gamma parameter, an aging parameter, a temperature parameter, or any combination thereof, as described above. At operation 805 one or more control loop parameter modifiers to modify one or more drive parameters of the LED source are generated using the pulse width modulation (PWM) waveform information. The one or more drive parameters are a drive voltage parameter, a drive current parameter, a drive power parameter, a drive duty cycle parameter, or any combination thereof, as described above. At operation 807 one or more control loop parameters are dynamically modified using the one or more control loop parameter modifiers and one or more second compensation values, as described above. At operation 809 a PWM dimming control waveform is generated based on the dynamically modified one or more control loop parameters, as described above.

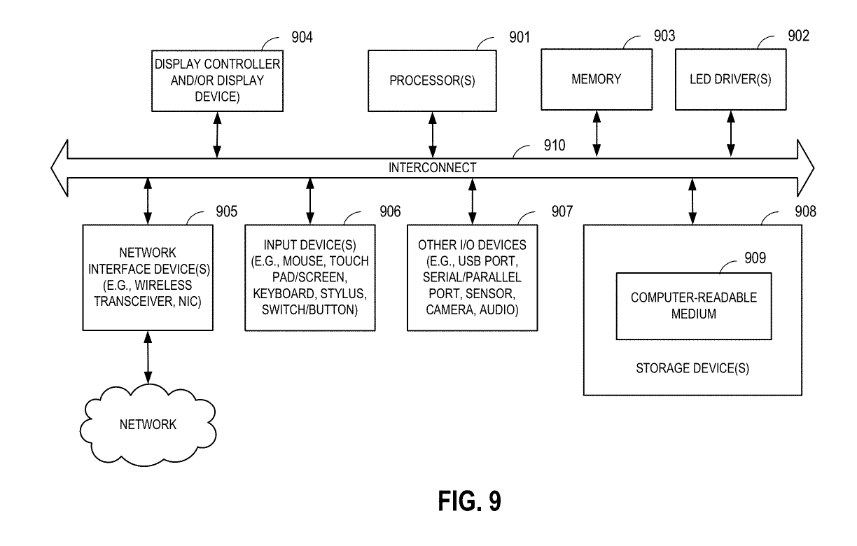

FIG. 9 is a block diagram illustrating an example of a data processing system 900 that includes one or more LED drivers 902, as described herein. For one embodiment, the one or more LED drivers 902 are represented by the LED driver 101, as described with respect to any of FIGS. 1-8. For example, system 900 may represent a data processing system for performing any of the processes or methods described above in connection with any of FIGS. 1-8. System 900 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 900 is intended to show a high-level view of many components of the computer system. However, it is to be understood that additional components may be present in certain implementations and furthermore, different arrangement of the components shown may occur in other implementations. System 900 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

For one embodiment, system 900 includes a processor 901, one or more LED drivers 902, a memory 903, and one or more network interface devices 905, one or more input devices 906 and other input/output devices 908 that are connected via a bus or an interconnect 910. Processor 901 may represent a single processor or multiple processors with a single processor core or multiple processor cores included therein. Processor 901 may represent one or more general-purpose processors such as a microprocessor, a central processing unit (CPU), or other processor. More particularly, processor 901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 901 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 901, which may be a low power multi-core processor socket such as an ultra-low voltage processor, may act as a main processing unit and central hub for communication with the various components of the system. Such processor can be implemented as a system on chip (SoC). Processor 901 is configured to execute instructions for performing the operations and/or steps discussed herein. System 900 may further include a graphics interface that communicates with optional graphics subsystem 904, which may include a display controller, a graphics processor, and/or a display device.

Processor 901 may communicate with one or more LED drivers 902 and memory 903. For one embodiment, memory 903 is implemented via multiple memory devices to provide for a given amount of system memory that incorporates one or more dimming commands of the one or more LED drivers 902. Memory 903 may include one or more volatile storage (or memory) devices such as random access memory (RAM), dynamic RAM (DRAM), synchronous DRAM (SDRAM), static RAM (SRAM), or other types of storage devices. Memory 903 may store information including sequences of instructions that are executed by processor 901 or any other device. For example, executable code and/or data of a variety of operating systems, device drivers, firmware (e.g., input output basic system or BIOS), and/or applications can be loaded in memory 903 and executed by processor 901. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Network interface device 905 may include a wireless transceiver and/or a network interface card (NIC). The wireless transceiver may be a WiFi transceiver, an infrared transceiver, a Bluetooth transceiver, a WiMax transceiver, a wireless panel assembly telephony transceiver, a satellite transceiver (e.g., a global positioning system (GPS) transceiver), or other radio frequency (RF) transceivers, or a combination thereof. The NIC may be an Ethernet card.

Input device(s) 906 may include a mouse, a touch pad, a touch sensitive screen (which may be integrated with display device 904), a pointer device such as a stylus, and/or a keyboard (e.g., physical keyboard or a virtual keyboard displayed as part of a touch sensitive screen). For example, input device 906 may include a touch screen controller coupled to a touch screen. The touch screen and touch screen controller can, for example, detect contact and movement or a break thereof using any of multiple touch sensitivity technologies, including but not limited to capacitive, resistive, infrared, and surface acoustic wave technologies, as well as other proximity sensor arrays or other elements for determining one or more points of contact with the touch screen.

I/O devices 907 may include an audio device. An audio device may include a speaker and/or a microphone to facilitate voice-enabled functions, such as voice recognition, voice replication, digital recording, and/or telephony functions. Other IO devices 907 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 907 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 910 via a sensor hub (not shown), while other devices such as a keyboard or thermal sensor may be controlled by an embedded controller (not shown), dependent upon the specific configuration or design of system 900.

To provide for persistent storage of information such as data, applications, one or more operating systems and so forth, a mass storage (not shown) may also couple to processor 901. In various embodiments, to enable a thinner and lighter system design as well as to improve system responsiveness, this mass storage may be implemented via a solid state device (SSD). For other embodiments, however, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. In addition, a flash device may be coupled to processor 901, e.g., via a serial peripheral interface (SPI). This flash device may provide for non-volatile storage of system software, including a basic input/output software (BIOS) as well as other firmware of the system.

Storage device 908 may include computer-accessible storage medium 909 (also known as a machine-readable storage medium or a computer-readable medium) on which is stored one or more sets of instructions or software embodying any one or more of the methodologies or functions described herein. Embodiments described herein may also reside, completely or at least partially, within memory 903, and/or within processor 901 during execution thereof by data processing system 900, memory 903, and processor 901 also constituting machine-accessible storage media. Modules, units, or logic configured to implement the embodiments described herein may further be transmitted or received over a network via network interface device 905.

Computer-readable storage medium 909 may also be used to store some software functionalities described above persistently. While computer-readable storage medium 909 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the embodiments described herein. The term “computer-readable storage medium” shall accordingly be taken to include, but not be limited to, solid-state memories, and optical and magnetic media, or any other non-transitory machine-readable medium.

Components and other features described herein can be implemented as discrete hardware components or integrated in the functionality of hardware components such as ASICS, FPGAs, DSPs, or similar devices. In addition, any of the components described above in connection with any one of FIGS. 1-9 can be implemented as firmware or functional circuitry within hardware devices. Further, these components can be implemented in any combination hardware devices and software components.

Note that while system 900 is illustrated with various components of a data processing system, it is not intended to represent any particular architecture or manner of interconnecting the components; as such, details are not germane to embodiments described herein. It will also be appreciated that network computers, handheld computers, mobile phones, servers, and/or other data processing systems, which have fewer components or perhaps more components, may also be used with embodiments described herein.

In the foregoing specification, embodiments have been described with reference to specific exemplary embodiments thereof. It will be evident that various modifications may be made thereto without departing from the broader spirit and scope. The specification and drawings are, accordingly, to be regarded in an illustrative sense rather than a restrictive sense.

1. A dimming light emitting diode (LED) system, comprising:
an LED driver; and
a switch-mode power supply controller coupled to the LED driver to drive an LED source, wherein the LED driver is configured to receive pulse width modulation (PWM) waveform information, wherein the LED driver is configured to determine one or more compensation values based on one or more LED parameters that include a photometric response parameter, a gamma parameter, an aging parameter, a temperature parameter, or any combination thereof, and wherein the LED driver is configured to modify one or more control loop parameters for the switch-mode power supply controller to dim the LED source based on the PWM waveform information and the one or more compensation values.

2. The dimming LED system of claim 1, wherein the LED driver is configured to determine one or more drive parameters to drive the LED source based on the modified one or more control loop parameters, and wherein the LED driver is configured to output a PWM control signal based on the determined one or more drive parameters.

3. The dimming LED system of claim 2, wherein the one or more drive parameters include a drive voltage parameter, a drive current parameter, a drive power parameter, a drive duty cycle parameter, or any combination thereof.

4. The dimming LED system of claim 1, wherein the PWM waveform information includes a PWM waveform slope, a PWM waveform shape, or any combination thereof.

5. (canceled)

6. The dimming LED system of claim 1, wherein the LED driver is configured to generate one or more control loop parameter modifiers based on at least the PWM waveform information.

7. The dimming LED system of claim 1, wherein the LED driver comprises an oscillator and a multiplier coupled to the oscillator to multiply at least one of a slope and a shape of the PWM waveform by the one or more control loop parameters.

8. A dimming light emitting diode (LED) driver circuit, comprising:
a memory; and
a management unit comprising a processor coupled to the memory, wherein the processor is configured to receive pulse width modulation (PWM) waveform information, wherein the processor is configured to determine one or more compensation values based on one or more LED parameters that include a photometric response parameter, a gamma parameter, an aging parameter, a temperature parameter, or any combination thereof, and wherein the processor is configured to modify one or more control loop parameters to dim a LED source based on the PWM waveform information and the one or more compensation values.

9. The dimming LED driver circuit of claim 8, wherein the processor is configured to determine one or more drive parameters to drive the LED source based on the modified one or more control loop parameters, and wherein the processor is configured to output a PWM control signal based on the determined one or more drive parameters.

10. The dimming LED driver circuit of claim 9, wherein the one or more drive parameters include a drive voltage parameter, a drive current parameter, a drive power parameter, a drive duty cycle parameter, or any combination thereof.

11. The dimming LED driver circuit of claim 8, wherein the PWM waveform information includes a PWM waveform slope, a PWM waveform shape, or any combination thereof.

12. (canceled)

13. The dimming LED driver circuit of claim 8, wherein the processor is configured to generate one or more control loop parameter modifiers based at least the PWM waveform information.

14. The dimming LED driver circuit of claim 8, wherein the processor is configured to multiply at least one of a slope and a shape of the PWM waveform by the one or more control loop parameters.

15. A method to dim an LED source comprising:
receiving pulse width modulation (PWM) waveform information;
determining one or more compensation values based on one or more LED parameters that include a photometric response parameter, a gamma parameter, an aging parameter, a temperature parameter, or any combination thereof and
modifying one or more control loop parameters to dim the LED source based on the PWM waveform information and the one or more compensation values.

16. The method of claim 15, further comprising
determining one or more drive parameters to drive the LED source based on the modified one or more control loop parameters, and
outputting a PWM control signal based on the determined one or more drive parameters.

17. The method of claim 16, wherein the one or more drive parameters include a drive voltage parameter, a drive current parameter, a drive power parameter, a drive duty cycle parameter, or any combination thereof.

18. The method of claim 15, wherein the PWM waveform information includes a PWM waveform slope, a PWM waveform shape, or any combination thereof.

19. (canceled)

20. The method of claim 15, further comprising
generating one or more control loop parameter modifiers based at least the PWM waveform information.

21. The method of claim 15, further comprising multiplying at least one of a slope and a shape of the PWM waveform by the one or more control loop parameters.

22. A non-transitory machine readable medium comprising instructions that cause a data processing system to perform a method to dim an LED source comprising:
receiving pulse width modulation (PWM) waveform information;
determining one or more compensation values based on one or more LED parameters that include a photometric response parameter, a gamma parameter, an aging parameter, a temperature parameter, or any combination thereof; and
modifying one or more control loop parameters to dim the LED source based on the PWM waveform information and the one or more compensation values.

23. The non-transitory machine readable medium of claim 22, wherein the method further comprises
determining one or more drive parameters to drive the LED source based on the modified one or more control loop parameters, and
outputting a PWM control signal based on the determined one or more drive parameters.

24. The non-transitory machine readable medium of claim 23, wherein the one or more drive parameters include a drive voltage parameter, a drive current parameter, a drive power parameter, a drive duty cycle parameter, or any combination thereof.

25. The non-transitory machine readable medium of claim 22, wherein the PWM waveform information includes a PWM waveform slope, a PWM waveform shape, or any combination thereof.

26. (canceled)

27. The non-transitory machine readable medium of claim 22, wherein the method further comprises
generating one or more control loop parameter modifiers based at least the PWM waveform information.

28. The non-transitory machine readable medium of claim 22, wherein the method further comprises
multiplying at least one of a slope and a shape of the PWM waveform by the one or more control loop parameters.
